(19) United States
(12) Patent Application Publication
(10) Pub. No.: US 2008/0313257 A1
(43) Pub. Date: Dec. 18, 2008

(54) Method and Apparatus for Policy-Based Transfer of an Application Environment

(76) Inventors: James D. Allen, Austin, TX (US); Steven A. King, Round Rock, TX (US)

Correspondence Address: IBM CORP (YA);C/O YEE & ASSOCIATES PC, P.O. BOX 802333, DALLAS, TX, 75380, US

(21) Appl. No.: 11/763,531

(22) Filed: Jun. 15, 2007

(51) Int. Cl. G06F 15/16

(52) U.S. Cl. 709/201

(57) ABSTRACT

A computer implemented method, apparatus, and computer program product for transferring an application environment between a plurality of computing devices. The process retrieves a set of transfer policies in response to detecting a presence of a second computing device in the plurality of computing devices. The set of transfer policies govern the transfer of the application environment from a first computing device. The process then determines whether conditions for the transfer have been satisfied. Conditions for transfer are specified by the set of transfer policies. The process subsequently transfers application data to the second computing device if the conditions for the transfer have been satisfied. The application data is used to create the application environment on the second computing device.

### BACKGROUND OF THE INVENTION

1. Field of the Invention

The present invention relates generally to an improved data processing system, and in particular, to a computer implemented method and apparatus for managing software applications. Still more particularly, the present invention relates to a computer implemented method, apparatus, and computer usable program product for providing a policy-based transfer of an application environment.

2. Description of the Related Art

Computing devices take many different forms. For example, computing devices may include a desktop personal computer (PC), a laptop, a personal digital assistant (PDA), a tablet (PC), and a digital or smartphone. Larger computing devices, such as the desktop PC, often have more power and storage capacity than their smaller and more portable counterparts. Further, desktop PCs and similar-sized devices are oftentimes easier to use because of their larger displays and user-friendly input devices. Smaller computing devices, such as a PDA or smartphone, may be more difficult to operate because of their more compact form factor, but offer portability and convenience to a user.

Because portable computing devices are often carried around with a user throughout the course of a day, the user may initially choose to execute an application on the portable computing device if a larger computing device, such as a desktop PC, is unavailable. However, once a desktop PC is available, the user may wish to continue the use of the application on the desktop PC where the display is larger and the input devices, such as a keyboard and mouse, are more comfortable and easier to use. For example, the user may initiate an instant messaging session on a PDA or smartphone while riding a train to the office. Once the user arrives at the office, the user may want to continue the instant messaging session on the desktop PC.

Currently, to continue the instant messaging session on the desktop PC, a user is required to initiate an entirely new instant messaging session. To this end, the user performs a number of intermediate steps, such as locating the messaging application in a program list, initiating the application, and locating the other party to the communication in a buddy list. Furthermore, the messaging history generated on the PDA is often unavailable to the user on the desktop PC, thus requiring the user to continually refer back to the PDA to review previously discussed topics.

Thus, although a user can execute the same program on a different computing device, the user often is unable to easily transfer the application environment from the first computing device to the second. The application environment is an environment that includes, for example, the operating system, application programming interfaces (APIs), data structures, memory usages, and user interface. In particular, with respect an instant messaging session, the application environment may include, without limitation, any program preferences selected by the user, such as a font type, security settings, macro functions, or any other preferences or settings associated with the execution of the messaging application. In addition, the application environment includes any data generated by a user in the operation of the messaging application.

Consequently, because the application environment cannot be easily transferred from the first computing device to the second, the user is often required to suffer the inconvenience of not having access to the same or similar application environment. Alternatively, the user is required to spend time and effort to alter the application environment to match the application environment that was created on the first computing device.

### SUMMARY OF THE INVENTION

The illustrative embodiments described herein provide a computer implemented method, apparatus, and computer program product for transferring an application environment. The process retrieves a set of transfer policies in response to detecting a presence of a second computing device in the plurality of computing devices. The set of transfer policies govern the transfer of the application environment from a first computing device. The process then determines whether conditions for the transfer have been satisfied. Conditions for transfer are specified by the set of transfer policies. The process subsequently transfers application data to the second computing device if the conditions for the transfer have been satisfied. The application data is used to create the application environment on the second computing device.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network data processing system in which illustrative embodiments may be implemented;

FIG. 2 is a block diagram of a first data processing system in which the illustrative embodiments may be implemented;

FIG. 3 is a block diagram of a second data processing system in which the illustrative embodiments may be implemented;

FIG. 4 is a diagram of a simplified system for transferring an application environment in accordance with an illustrative embodiment; and

FIG. 5 is a flowchart of a process for the transfer of an application environment in accordance with an illustrative embodiment.

### DETAILED DESCRIPTION OF THE PREFERRED EMBODIMENT

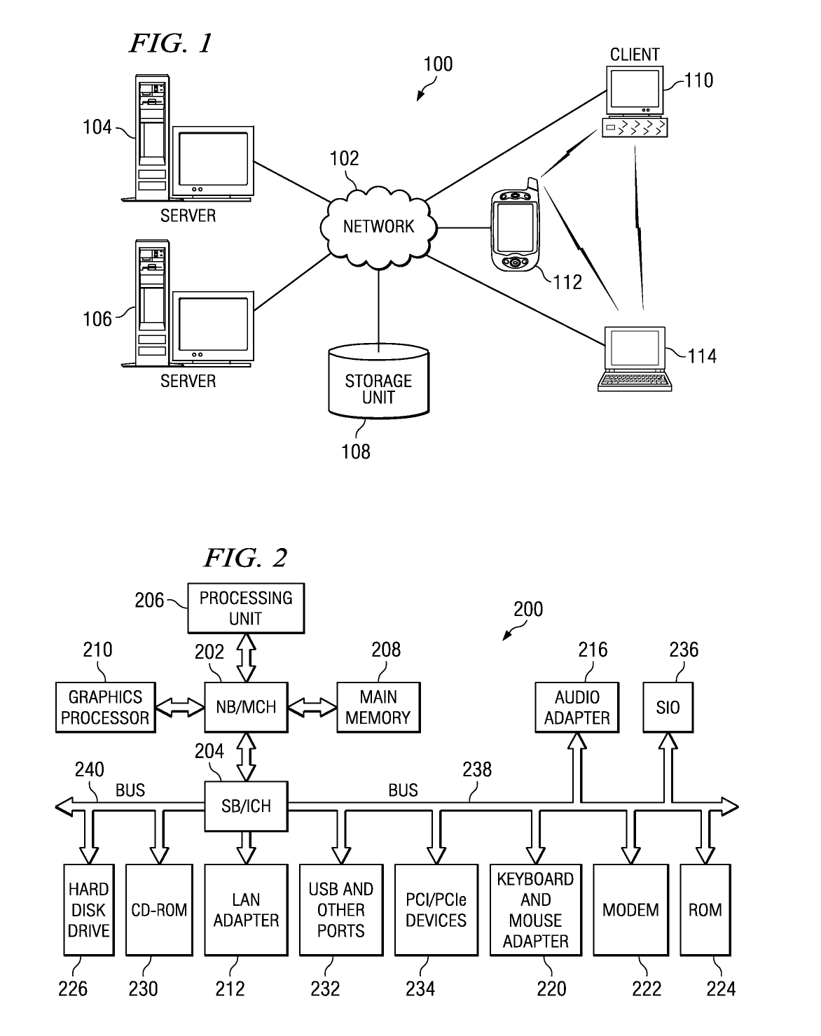

With reference now to the figures, and in particular, with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage 108. In addition, client 110, PDA 112, and laptop 114 connect to network 102. Client 110 may be, for example, personal computers or network computers. In the depicted example, server 104 provides data, such as boot files, operating system images, and applications to client 110, PDA 112, laptop 114. Client 110, PDA 112, and laptop 114 are clients to server 104 in this example. Network data processing system 100 may include additional servers, clients, and other computing devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

Client 110, PDA 112, and laptop 114 may communicate to one another via network 102. In addition, client 110, PDA 112, and laptop 114 may communicate to one another by means of a direct communications link. For example, client 110, PDA 112, and laptop 114 may be communicatively coupled to one another through a Bluetooth® connection, or any similar form wireless communication, such as infrared or Wi-Fi.

With reference now to FIG. 2, a first block diagram of a data processing system is shown in which illustrative embodiments may be implemented. Data processing system 200 is an example of a computer, such as server 104, client 110, or laptop 114 in FIG. 1, in which computer usable program code or instructions implementing the processes may be located for the illustrative embodiments.

In the depicted example, data processing system 200 employs a hub architecture including a north bridge and memory controller hub (NB/MCH) 202 and a south bridge and input/output (I/O) controller hub (SB/ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the NB/MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238, and hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the JAVA™ programming system, may run in conjunction with the operating system and provides calls to the operating system from JAVA™ programs or applications executing on data processing system 200. JAVA™ and all JAVA™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

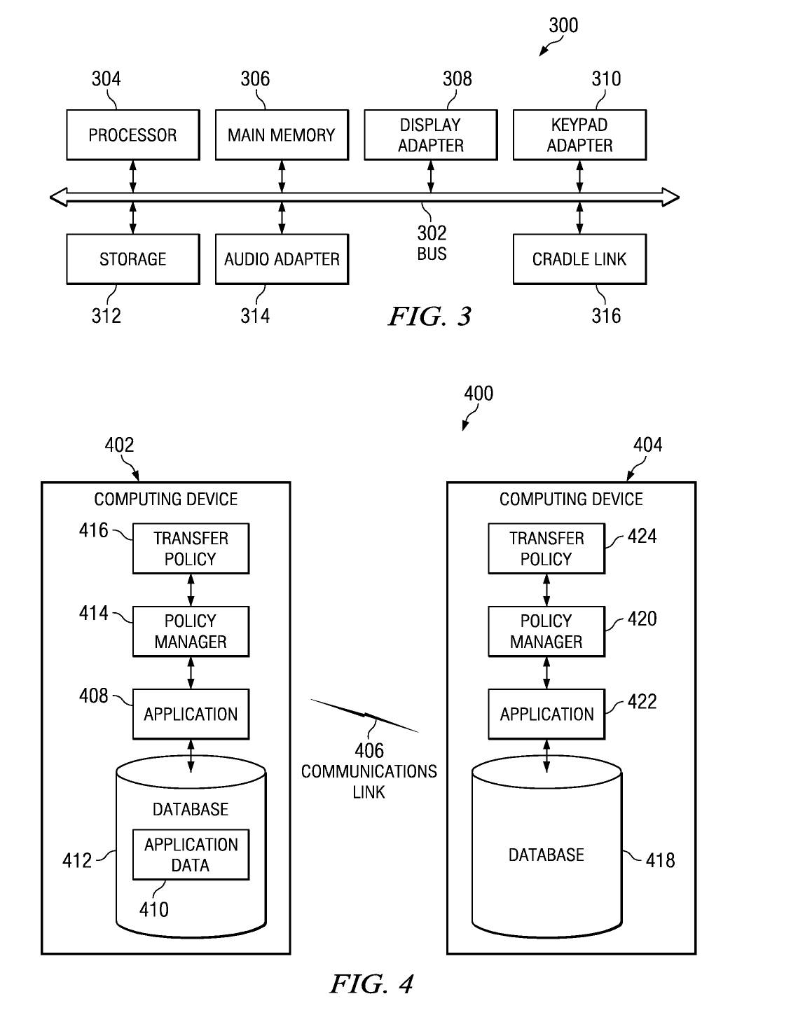

Turning now to FIG. 3, a block diagram of a PDA is shown in accordance with an illustrative embodiment. PDA 300 is an example of a PDA, such as PDA 112 in FIG. 1, in which code or instructions implementing the processes of the present invention may be located. PDA 300 includes a bus 302 to which processor 304 and main memory 306 are connected. Display adapter 308, keypad adapter 310, storage 312, and audio adapter 314 also are connected to bus 302. Cradle link 316 provides a mechanism to connect PDA 300 to a cradle used in synchronizing data in PDA 300 with another data processing system. Further, display adapter 308 also includes a mechanism to receive user input from a stylus when a touch screen display is employed.

An operating system runs on processor 304 and is used to coordinate and provide control of various components within PDA 300 in FIG. 3. The operating system may be, for example, a commercially available operating system such as Windows® Mobile (Windows is a trademark of Microsoft Corporation in the United States, other countries, or both), and is available from Microsoft Corporation. Instructions for the operating system and applications or programs are located on storage devices, such as storage 312, and may be loaded into main memory 306 for execution by processor 304.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3.

The hardware in FIGS. 1-3 may vary depending on the implementation. Other internal hardware or peripheral devices, such as flash memory, equivalent non-volatile memory, or optical disk drives and the like, may be used in addition to or in place of the hardware depicted in FIGS. 1-3. Also, the processes of the illustrative embodiments may be applied to a multiprocessor data processing system.

The illustrative embodiments described herein provide a computer implemented method, apparatus, and computer program product for transferring an application environment. The illustrative embodiments described herein provide a computer implemented method, apparatus, and computer program product for transferring an application environment. The process retrieves a set of transfer policies in response to detecting a presence of a second computing device in the plurality of computing devices. The set of transfer policies contains one or more transfer policies. The set of transfer policies govern the transfer of the application environment from a first computing device. The process then determines whether conditions for the transfer have been satisfied. Conditions for transfer are specified by the set of transfer policies. The process subsequently transfers application data to the second computing device if the conditions for the transfer have been satisfied. The application data is used to create the application environment on the second computing device.

The set of transfer policies governs which application environments may be transferred and the manner in which the transfer may occur. For example, the transfer policies may define one or more conditions for transfer. Conditions for transfer may be based upon any number of rules including, but not limited to, a location of the computing devices, a particular feature of the computing devices, a detectable motion of the computing devices, a time of day, or a calendar entry.

Turning now to FIG. 4, a diagram of a simplified system for transferring an application environment is depicted in accordance with an illustrative embodiment. System 400 includes computing devices 402 and 404, which may be computing devices such as client 110, PDA 112, and laptop 114 in FIG. 1. Computing device 402 is in communication with computing device 404 via communications link 406. Communications link 406 is a wireless communications link, such as Bluetooth®, infrared, or, wireless fidelity (Wi-Fi). In the illustrative examples discussed below, an application environment is transferred from computing device 402 to computing device 404.

Computing device 402 is operable by a user to run application 408. Application 408 is any type of software application that may be executed in a computing device, such as, for example, an email program, instant messenger application, or a word processing application. The user generates application data 410 during the execution of application 408. Application data 410, which is stored in database 412, is data necessary for recreating the application environment on computing device 404. For example, where a user is operating computing device 402 to carry on an instant messaging session with another person, the chat history and program settings may be stored in application data 410. Program settings may include, for example, security settings and user preferences, such as a selected font type or the election to display timestamps also may be part of application data 410.

The user executing application 408 on computing device 402 may have a need to transfer the application environment to computing device 404. For example, a user may have initiated an instant messaging conversation on a portable computing device while on the way into the office. However, upon arriving at the office, the user may want to resume the conversation on a desktop PC where the display screen is larger and the keyboard is easier to use. In this illustrative example, the portable computing device is computing device 402 while the desktop PC is computing device 404.

Policy manager 414 performs the transfer of the application environment from computing device 402 to computing device 404. Policy manager 414 is a software application operable to transfer application environments from computing device 402. In particular, policy manager 414 transfers an application environment by transferring application data 410 to another computing device, such as computing device 404. Application data 410 is then usable by computing device 404 to recreate the application environment originally generated in computing device 402.

The transfer of an application environment from computing device 402 to computing device 404 may be initiated by a user. For example, in one embodiment, policy manager 414 is a software application having a graphical user interface that is displayed when a user initiates policy manager 414. The user can utilize the graphical user interface to effect a transfer of an application environment from computing device 402 to computing device 404.

In an alternate embodiment, the transfer of the application environment may be automatically initiated by policy manager 414. In this embodiment, policy manager 414 may detect the presence of computing device 404 and automatically retrieve transfer policy 416 to determine whether any application executing on computing device 402 is a proper candidate for transfer to computing device 404. The presence of computing device 404 may be determined once a communications link between the devices has been established. The communications link may be through a network, such as network 102 in FIG. 1, or through a direct wireless connection, such as Bluetooth®, infrared, or Wi-Fi.

The actual transfer of application data 410 by policy manager 414 is governed by transfer policy 416. Transfer policy 416 is a set of one or more rules that specify what application environments are transferable, and if so, what conditions must first be satisfied before the transfer can occur. Before an application environment is transferred, policy manager 414 must confirm that the conditions for transfer have been satisfied. The rules and conditions set forth in transfer policy 416 may be defined by an administrator when an application, such as application 408, is initially installed on computing device 402. Alternatively, these rules may be defined when an application is initiated, prior to transfer. Transfer policy 416 may contain any number of rules, such as, for instance, a requirement that policy manager 414 ceases the execution of application 408 upon successfully transferring application data 410 to computing device 404.

Once application data 410 is received by computing device 404, application data 410 may be stored in database 418. At this time or sometime thereafter, policy manager 420 initiates application 422 using application data 410, thereby completing the transfer of the application environment to computing device 404. In an alternate embodiment, before policy manager 420 initiates application 422, policy manager 420 retrieves transfer policy 424 to confirm that a policy does not exist that would prevent or otherwise limit the execution of application 422 using application data 410.

Transfer policy 416 may specify any number of rules and conditions for controlling the transfer of an application environment. For instance, a condition for transfer may be based upon the detection of a specific feature of computing device 404. The required feature defined in transfer policy 416 may be, for example, the feature of “portability.” Portability may be assigned to portable computing devices, such as PDAs, laptop computers, and tablet PCs, whereas a desktop PC may be defined as non-portable. In this manner, transfer policy 416 may allow or prohibit the transfer of an application environment from computing device 402 to computing device 404 based upon whether one or more of the devices may be easily moved from one location to another.

Transfer policy 416 may include another rule allowing the transfer of an application environment based upon a feature relating to the origin of manufacture of computing device 404. For example, a rule may exist specifying that an application environment may be restricted if policy manager 414 cannot confirm that computing device 404 was manufactured by an approved manufacturer. The approved manufacturer may be set forth in transfer policy 416. This restriction may prevent policy manager 414 from transferring an application environment in its entirety, or may allow a transfer of the application environment with limited functionality such that only certain aspects of an application environment are accessible to a user operating computing device 404.

Another feature required by transfer policy 416 may be based on the compatibility of software and/or hardware present in computing device 404. For example, transfer policy 416 may set forth a list of preferred hardware configurations, operating systems, or computer programs, the presence or absence of which may ultimately determine whether an application environment may be transferred to computing device 404. For example, transfer policy 416 may prevent transfer of an application environment to computing device 404 if computing device 404 lacks adequate processor power to run the application environment. Similarly, an application environment may be configured to run optimally on a browser application, such as the Mozilla® web browser. In this case, transfer policy 416 may prevent a transfer of an application environment to computing device 404 if policy manager 414 detects that computing device 404 is running a different web browser.

Transfer policy 416 may also set forth a rule for the transfer of an application environment based upon a location of one or more devices in the plurality of computing devices. The location can be a current location, or some location that the device will be at in a future time period. For example, where computing device 402 is a desktop PC, policy manager 414 may receive information indicating that the user is at the office.

Consequently, policy manager 414 may maintain the execution of application 408 and its associated application environment at computing device 402. However, if policy manager 414 receives information that the user is or will be located at some different location other than in the presence of computing device 402, then transfer policy 416 may require policy manager 414 to transfer the application environment to computing device 404. The different location may be, for example, such as on a bus, at a grocery store, or any other number of locations. Thus, the user will have access to the application environment based upon a location of one or more computing devices. In this example, computing device 404 is a portable computing device, such as a PDA.

The location of the computing devices may be determined by any number of methods. For example, in one embodiment, the location may be specified by a user in response to receiving a prompt generated by policy manager 414. The prompt may be generated once a user has initiated an application, such as application 422. In addition, a location of the computing devices may be determined automatically, via a global positioning satellite (GPS) component embedded in a computing device or a software application that triangulates the location of a cellular phone based upon communications with cellular phone towers.

Transfer policy 416 may include a condition for transfer based upon a schedule. This schedule may be a calendar entry. For example, a user may program a condition into transfer policy 416 requiring that policy manager 414 transfer an application environment from computing device 402 to computing device 404 for a specific week in December when the user will be on vacation. In addition, the schedule can include a time of day. The time of day may be provided in the calendar entry, or the user may define a separate condition based solely upon a time of day. For example, a user may specify that transfer policy 416 must transfer an application environment to computing device 404 from 8:00 am to 5:00 pm every day.

Transfer policy 416 may include a condition governing the transfer of an application environment based on an identity of a customer. The identity of a customer is an identifier. The identifier may specify a defining characteristic of the customer, such as, for example, the customer's name, social security number, job title, address, place of employment, marital status, or any other category that may be associated with a customer and defined in transfer policy 416. The identifier may then be associated with one or more applications executing on computing device 404. For example, if policy manager 414 receives information from a user that the user is planning on meeting with a customer, policy manager 414 may prompt the user for additional information, such as the customer's identity. The user, located at the office and operating computing device 402, which is the user's desktop PC, provides the requested information. Before the user leaves the office to meet the customer, policy manager 414 transfers one or more application environments to computing device 404, which is the user's laptop or PDA. Thus, the user will have all the required application environments available in computing device 404 in order to complete a transaction with the customer having the specified identity.

Transfer policy 416 may include, for example, a condition allowing the transfer of an application environment based upon the identity of one or more computing devices in the presence of computing device 402. The identity of a computing device, such as computing device 404, is any type of identifier of a computing device, such as, for example, the make and model of the computing device, a unique serial number, or a user-assigned name. This identifier may be stored in memory and transmitted to computing device 402 when computing device 404 sends the initial signal to computing device 402 to establish a presence of computing device 404. In this manner, transfer policy 416 may limit the transfer of an application environment from computing device 402 to a specific computing device having a predetermined identity.

In the depicted embodiments, transfer policy 416 may include a condition for transfer based upon the detection of motion of a computing device. For example, transfer policy 416 may specify that an application environment should be transferred to or remain on any portable computing device that is in motion. Motion can be detected any number of ways, such as by a component incorporated into the computing device that detects movement. In addition, movement can be determined by a GPS component that provides to policy manager 414 periodic updates as to the location of computing device 402. If the location of computing device 402 is changing from one update to the next, then computing device 402 is in motion.

Thus, if a user is at the office and carrying computing device 402 from one location to the next, policy manager 414 will receive information indicating that the user is constantly in motion. Consequently, the user is not merely sitting at a desk and an application environment should not be transferred to the user's desktop PC, which is represented by computing device 404.

A transfer policy may also include a condition that requires transfer of an application environment from a first computing device to a second computing device based on the detection of a threshold signal strength of the first computing device. For example, a user may be operating computing device 402, a PDA, to carry on an instant messaging session. However, the user may be located in an area where computing device 402 has a weak signal strength. The user may have nearby computing device 404, a laptop. Thus, if policy manager 414 receives information that the signal strength of computing device 402 drops below a certain threshold level, policy manager 414 may transfer the instant messaging application environment to computing device 404. Policy manager 414 may then display a notice to the user that the transfer was made so that the user can resume the conversation on computing device 404. The notice may take the form of a simple popup window on the display screen of computing device 402.

In the illustrative example in FIG. 4, computing device 402 transfers application data 410 to computing device 404 so that a user can transfer an application environment on computing device 404. However, in another embodiment, computing device 404 may be an intermediate computing device that may not have permission to execute the transferred application environment. Instead, computing device 404 may be used as a storage device for the purpose of transferring application data 410 to a third computing device (not shown).

For example, a user may initiate an instant messaging application on computing device 402, a desktop PC at the user's office. Before completing the messaging session, the user may leave for home. Computing device 402 may transfer application data 410 to computing device 404—the user's PDA—in accordance with transfer policy 416. However, policy manager 420 may prevent the user from continuing the messaging session on computing device 404 because, for example, policy manager 420 prevents that particular application environment from executing on a portable computing device. However, once policy manager 420 confirms that the user has arrived home, policy manager 420 may transfer application data 410 to the user's home desktop PC to continue the messaging session.

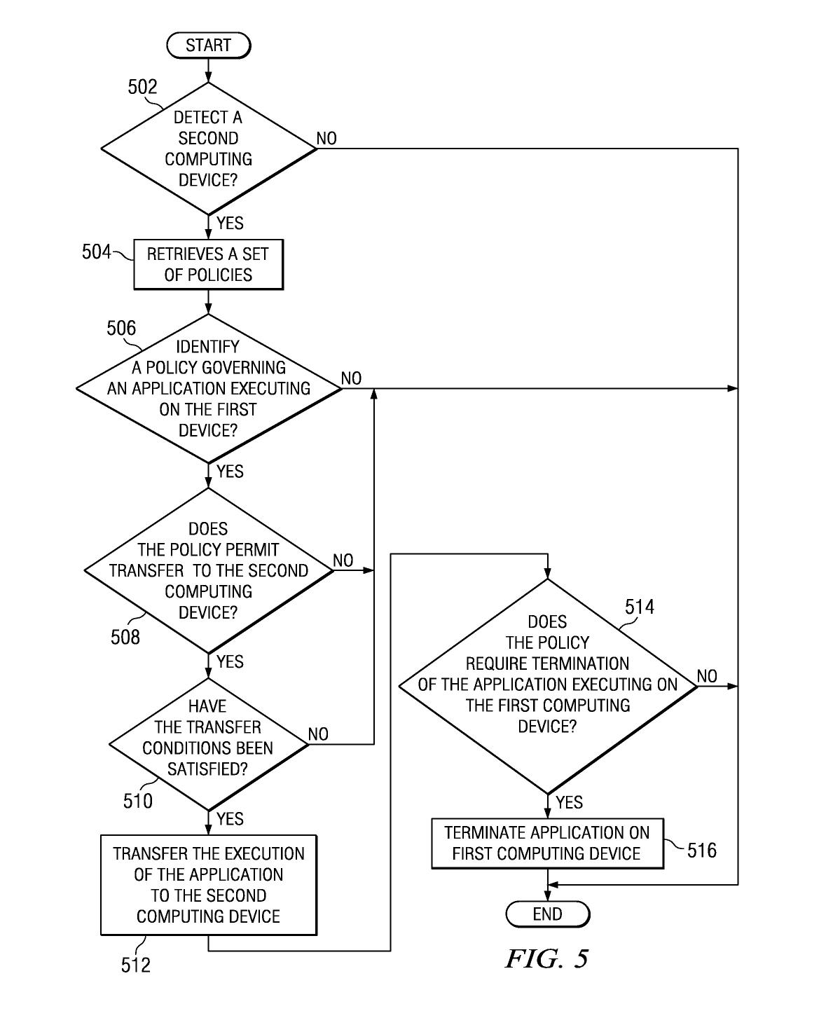

Turning now to FIG. 5, a flowchart of process for the transfer of an application environment is depicted in accordance with an illustrative embodiment. In this illustrative embodiment in FIG. 5, the process may be performed by a software component in a computing device, such as policy manager 414 of computing device 402 in FIG. 4.

The process begins by making the determination as to whether a second computing device has been detected (step 502). If the process makes the determination that a second computing device is not detected, then the process terminates thereafter. However, if the process makes the determination that a second computing device is detected, the process retrieves a set of policies (step 504).

The process makes the determination as to whether a policy in the set of policies has been identified that governs the transfer of an application environment on the first computing device (step 506). If the process makes the determination that no such policy exists then the process terminates thereafter. However, if the process makes the determination that there exists a policy in the set of policies that governs the transfer of an application on the first computing device, the process makes the determination as to whether the policy permits transfer of the application to the second computing device (step 508). If the policy does not permit transfer, then the process terminates thereafter.

If the process makes the determination that the policy does permit transfer of the application environment from the first computing device, then the process makes the determination as to whether the transfer conditions have been satisfied (step 510). If the transfer conditions have not been satisfied, then the process terminates thereafter. However, if the process makes the determination that the transfer conditions have been satisfied, then the process transfers the application data from the first computing device to the second computing device (step 512).

The process then makes the determination as to whether the policy requires the termination of the application executing on the first computing device (step 514). If the process makes the determination that the policy does not require the termination of the application executing on the first computing device, the process terminates. However, if the process makes the determination that the policy requires termination of the application executing on the first computing device, the process terminates that application (step 516). The process also terminates thereafter.

The flowcharts and block diagrams in the different depicted embodiments illustrate the architecture, functionality, and operation of some possible implementations of methods, apparatus, and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

Thus, the illustrative embodiments provide a computer implemented method, apparatus, and computer program product for transferring an application environment. The process retrieves a set of transfer policies in response to detecting a presence of a second computing device in the plurality of computing devices. The set of transfer policies govern the transfer of the application environment from a first computing device. The process then determines whether conditions for the transfer have been satisfied. Conditions for transfer are specified by the set of transfer policies. The process subsequently transfers application data to the second computing device if the conditions for the transfer have been satisfied. The application data is used to create the application environment on the second computing device.

Using this method and apparatus disclosed herein, a user may easily and automatically transfer an application environment from one computing device to another. In addition, a systems administrator can prevent or limit the transfer of the application environment to maintain security of the application environment and its associated data being transferred.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for transferring an application environment between a plurality of computing devices, the computer implemented method comprising:
responsive to detecting a presence of a second computing device in the plurality of computing devices, retrieving a set of transfer policies, wherein the set of transfer policies govern a transfer of the application environment from a first computing device;
determining whether conditions for the transfer have been satisfied, wherein the conditions for the transfer are specified by the set of transfer policies; and
transferring application data to the second computing device if the conditions for the transfer have been satisfied, wherein the application data is used to create the application environment on the second computing device.

2. The computer implemented method of claim 1 further comprising:
creating the application environment on the second computing device in response to receiving the application data at the second computing device.

3. The computer implemented method of claim 1, further comprising:
responsive to transferring the application data to the second computing device, terminating the application environment on the first computing device.

4. The computer implemented method of claim 1, wherein the conditions for transfer include detecting a feature of the second device, and wherein the feature is specified by the set of transfer policies.

5. The computer implemented method of claim 1, wherein the conditions for transfer include detecting a threshold signal strength.

6. The computer implemented method of claim 1, wherein the set of transfer policies is based on an identity of a customer.

7. The computer implemented method of claim 1, wherein the conditions for transfer include identifying a location of at least one computing device from the plurality computing devices.

8. The computer implemented method of claim 1, wherein the conditions for transfer include detecting a motion of the first computing device.

9. The computer implemented method of claim 1, wherein the set of transfer policies is based on a schedule.

10. The computer implemented method of claim 1, wherein the set of transfer policies is based on an identity of the second computing device.

11. The computer implemented method of claim 9 further comprising:
displaying a notice to a user, wherein the notice indicates the identity of the second computing device to which the application environment was transferred.

12. A computer program product comprising:
computer usable program code for transferring an application environment between a plurality of computing devices, the computer implemented method comprising:
computer usable program code for retrieving a set of transfer policies in response to detecting a presence of a second computing device in the plurality of computing devices, wherein the set of transfer policies govern a transfer of the application environment from a first computing device;
computer usable program code for determining whether conditions for the transfer have been satisfied, wherein the conditions for transfer are specified by the set of transfer policies; and
computer usable program code for transferring application data to the second computing device if the conditions for transfer have been satisfied, wherein the application data is used to create the application environment on the second computing device.

13. The computer program product of claim 12 further comprising:
computer usable program code for creating the application environment on the second computing device in response to receiving the application data at the second computing device.

14. The computer program product of claim 12 further comprising:
computer usable program code for terminating the application environment on the first computing device in response to transferring the application data to the second computing device.

15. The computer program product of claim 12, wherein the conditions for transfer include detecting a feature of the second device, and wherein the feature is specified by the set of transfer policies.

16. The computer program product of claim 12, wherein the conditions for transfer include detecting a threshold signal strength.

17. The computer program product of claim 11, wherein the set of transfer policies is based on an identity of a customer.

18. The computer program product of claim 11, wherein the conditions for transfer include identifying a location of at least one computing device from the plurality of computing devices.

19. The computer program product of claim 11, wherein the set of transfer policies is based on an identity of the second computing device.

20. A system for transferring an application environment between a plurality of computing devices, the system comprising:
a first computing device, wherein the first computing device retrieves a set of transfer policies in response to detecting a presence of a second computing device in the plurality of computing devices, and wherein the set of transfer policies govern a transfer of the application environment from a first computing device; determining whether conditions for the transfer have been satisfied, wherein the conditions for transfer are specified by the set of transfer policies; and transfers application data to a second computing device if the conditions for transfer have been satisfied, wherein the application data is used to create the application environment on the second computing device; and
a second computing device, wherein the second computing device transmits a signal to the first computing device, and wherein the signal indicates a presence of the second computing device; receives application data from the first computing device, wherein the application data is used to create an application environment originating from the first computing device; and initiates an application using the application data received from the first computing device.
